(19) United States
(12) Patent Application Publication
(10) Pub. No.: US 2013/0055985 A1
(43) Pub. Date: Mar. 7, 2013

(54) METHOD FOR OPERATING AN INTERNAL COMBUSTION ENGINE

(71) Applicant: GE JENBACHER GMBH & CO OHG, Jenbach (AT)

(72) Inventors: Friedrich GRUBER, Hippach (AT); Guenther WALL, Bad Haring (AT)

(73) Assignee: GE JENBACHER GMBH & CO OHG, Jenbach (AT)

(21) Appl. No.: 13/649,181

(22) Filed: Oct. 11, 2012

Related U.S. Application Data
(63) Continuation of application No. PCT/AT2011/000095, filed on Feb. 28, 2011.

(30) Foreign Application Priority Data
Apr. 14, 2010 (AT) A 592/2010

(51) Int. Cl. F02B 19/00

(52) U.S. Cl. 123/253

(57) ABSTRACT

Method for operating an internal combustion engine, in particular a gas spark-ignition engine with prechamber ignition, wherein the prechamber is supplied from the outside with a gas mixture as a scavenging gas whose CO₂ content is subjected to open-loop or closed-loop control, and wherein hydrogen is additionally added to the scavenging gas.

The invention concerns a method of operating an internal combustion engine, in particular a gas Otto cycle engine with prechamber ignition, wherein a gas mixture is fed to the prechamber from the exterior as scavenging gas.

The invention can be used for example in an internal combustion engine, in particular a gas Otto cycle engine with prechamber ignition, including a combustion chamber having a fuel inlet and a fuel outlet, which opens into an exhaust tract, wherein there is provided a prechamber in which there can be arranged an ignition device with which a fuel-air mixture can be ignited in the prechamber, wherein there is provided a fluid inlet opening into the prechamber.

In the case of internal combustion engines operated on the basis of the Otto cycle ignition of a fuel-air mixture is effected in the combustion chamber by ignition devices, wherein mixture ignition is mostly initiated by a spark flashover at the electrodes of a spark plug. Particularly in the case of gas engines in which a fuel-gas mixture is ignited, the lean-burn concept is used in respect of larger combustion chamber volumes. That means that there is a relatively large excess of air, whereby with maximum power density and at the same time a high level of efficiency of the engine the pollutant emission and thermal loading on the components are kept as low as possible. Ignition and combustion of very lean fuel-air mixtures represents in that respect a considerable challenge in terms of development and operation of modern high-power gas engines.

As from a certain structural size of the gas engines (generally approximately above six liters cubic capacity) it is necessary to use ignition boosters in order to cover the correspondingly large flame paths in the combustion chambers of the cylinders in the shortest possible time. Prechambers usually serve as such ignition boosters, wherein the fuel-air mixture which is highly compressed at the end of the compression stroke is ignited in a relatively small secondary chamber divided from the main combustion chamber of the cylinder. In that case a main combustion chamber is defined by the working piston, the cylinder sleeve and the cylinder head surface, wherein the secondary chamber (the prechamber) is connected to the main combustion chamber by one or more flow transfer bores. Frequently such prechambers are scavenged or filled with fuel gas during the charge change phase in order to enrich the fuel-air mixture and thus improve the ignition and combustion properties. For that purpose a small amount of fuel gas is branched from the fuel gas feed to the main combustion chamber and introduced into the prechamber by way of a suitable feed device provided with a non-return valve. During the charge change that amount of fuel gas scavenges the prechamber and is therefore often referred to as a scavenging gas.

During the compression phase the very lean fuel-air mixture of the main combustion chamber flows into the prechamber through the flow transfer bores and is mixed therein with the scavenging gas. The ratio of fuel to air in the mixture is specified in the form of the air excess index λ. In that respect λ=1 means that the amount of air present in the mixture precisely corresponds to that amount required to permit complete combustion of the amount of fuel. In such a case combustion takes place stoichiometrically. Large gas engines are usually operated under full load conditions with a lean mixture with a of between about 1.9 and 2.0, that is to say the amount of air in the mixture is approximately twice as great as the stoichiometric amount of air. Scavenging of the prechamber with fuel gas, after mixing with the fuel gas-air mixture from the main combustion chamber, results in a mean λ in the prechamber of between about 0.8 and 0.9. That entails optimum ignition conditions and, because of the energy density, intensive ignition flares which issue into the main combustion chamber and lead to rapid burning of the fuel-air mixture in the main combustion chamber. At such values however combustion occurs at a maximum temperature level so that the wall temperatures in the prechamber region are also correspondingly high.

DE 10 2008 015 744 A1 discloses an internal combustion engine in which exhaust gas is fed to a prechamber. The object of that specification is to avoid preignition phenomena by a procedure whereby the air excess index λ is increased by the introduction of exhaust gas into the prechamber by way of a separate nozzle, to such an extent that the mixture is no longer ignitable. That is to be attributed to the fact that the prechamber shown here is a device for compression ignition with a glow ignition device and premature ignition must be prevented in such systems.

The object of DE 103 56 192 A1 is to use hydrogen to compensate for fluctuations in gas quality.

With an increasing increase in engine power output and by virtue of the measures for increasing the level of efficiency, soot formation increasingly occurs in the prechamber. The soot content resulting therefrom in the engine exhaust gas leads to impairment of the transfer of heat in the waste-heat boiler and problems in the specific application of gas engines, for example for CO₂ fertilisation of greenhouses.

A possible way of avoiding soot formation involves leaning off the fuel-air mixture in the prechamber and oxidising the free carbon by a slight oxygen excess. In that case however other problems arise, related to the fact that excess oxygen at the very high combustion temperatures just above λ=1 can lead to hot corrosion at critical locations in the prechamber, in particular at the flow transfer bores and at the spark plug electrodes.

The object of the present invention is to provide a remedy here and to avoid soot formation and hot corrosion.

That object is attained by a method of operating an internal combustion engine as set forth in claim 1. According to the invention the CO₂ content of the scavenging gas (gas-air mixture) in the prechamber is adjusted prior to ignition in a defined manner but generally increased. In addition hydrogen is added to the scavenging gas.

The CO₂ content of the scavenging gas can preferably be in a range of greater than 0.039% (390 ppm) and less than about 30%.

The limits for the CO₂ content in the scavenging gas can be established in dependence on the engine power output, for example above 75% engine power output a CO₂ content of more than 10% and/or below 25% engine power output a CO₂ content of less than 5%.

The proposed solution provides that the prechamber is scavenged with scavenging gas, wherein the combustion characteristics of the gas-air mixture in the prechamber are influenced by a suitable scavenging gas composition in such a way that in particular soot formation is suppressed. That property can be achieved when CO₂ is added to the scavenging gas. In that respect it is conceivable on the one hand that CO₂ is supplied in the form of a pure gas or a gas mixture with a corresponding CO₂ content. On the other hand however it would also be conceivable for the CO₂ to come from the exhaust gas of the internal combustion engine. In particular the variant of taking the CO₂ from the exhaust gas by exhaust recycling has the advantage that there is no need for a separate CO₂ source.

Control or regulation of the CO₂ content can be effected by the engine control system.

It will be noted however that in order not to crucially worsen the ignition properties of the fuel-air mixture it is necessary to add a given amount of H₂ in addition to the CO₂. In that respect the ratio of CO₂ to H₂ is advantageously to be so adjusted that the worsening of the combustion properties of the gas mixture in the prechamber, that is generally linked to an increase in CO₂, is compensated. Precise metering and regulation of the composition of the scavenging gas for optimum operation of the internal combustion engine is therefore desirable.

As a dedicated supply for the internal combustion engine with a matched CO₂ to H₂ mixture, for example from a gas tank, is costly, it can advantageously be provided that an ideal or favorable composition of the scavenging gas is produced by thermochemical alteration of a mixture of existing substance flows.

Substance flows which are involved in gas engines and which can be used for this purpose are for example the fuel gas, the induction air and the engine exhaust gas.

Suitable thermochemical alteration in the gas composition can be achieved for example by partial oxidation with the presence of given catalysts. A disadvantage of partial oxidation for the intended use is the high carbon monoxide formation rate which is detrimental to the desired carbon dioxide. To eliminate that disadvantage and to improve the adjustability of the chemical reaction and the flexibility of the arrangement it is proposed that a small part of the engine exhaust gas is used in addition to the fuel gas employed and a given proportion of air and an amount of water vapor as an input substance into the thermochemical reactor. The thermochemical reactor can in that case be a vapor reformer.

The optimum composition of the scavenging gas depends inter alia on the load condition of the engine. Under full load the ratio of CO₂ to H₂ should desirably be greater than 0.5, while upon starting and with a small part load it should be less than 0.5.

With the thermochemical device based on the stated input substance flows the desired composition can be achieved by the for partial oxidation and the ratios of the substance flows of gas, air, water vapor and exhaust gas being suitably adapted to each other. As in any case a certain amount of water vapor is present in the exhaust gas the amount of externally generated H₂O vapor can be correspondingly reduced thereby.

As is familiar to the man skilled in the art, the method implementation and the catalysts used are to be designed for the desired purpose. In principle, besides partial oxidation, other methods would also be conceivable or possible, which lead to the desired gas composition for the scavenging gas.

A sensor for CO₂ may be adequate in terms of sensor system in the case of regulation. Preferably there are also sensors for hydrogen and/or carbon monoxide.

Further advantages and details are described with reference to the specific description and the accompanying Figures.

In the Figures:

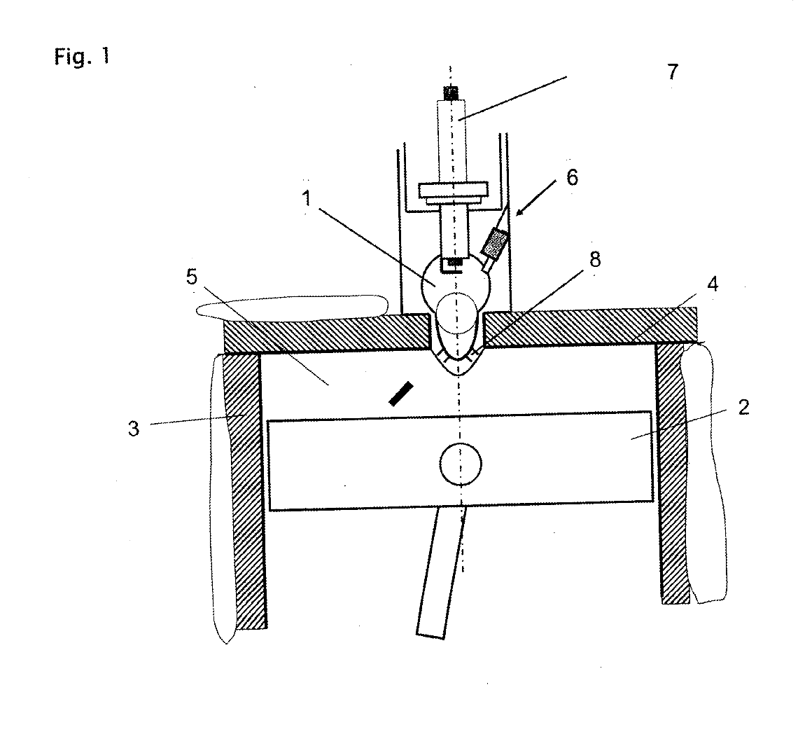

FIG. 1 shows a diagrammatic cross-sectional view of an internal combustion engine or a method according to the invention,

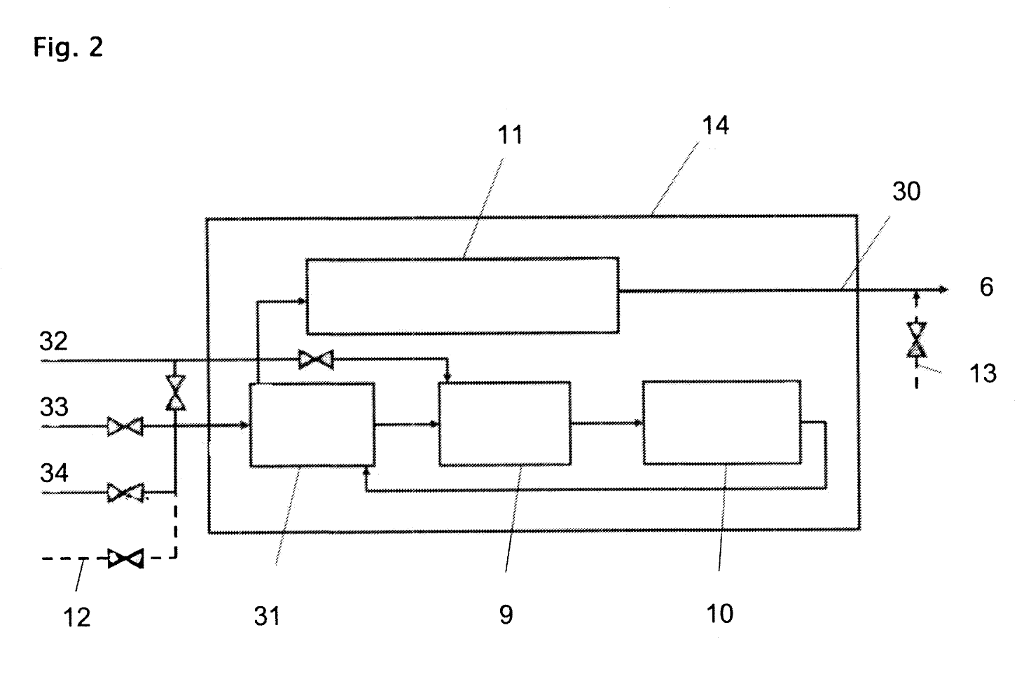

FIG. 2 shows a diagrammatic structure of a thermochemical reactor, and

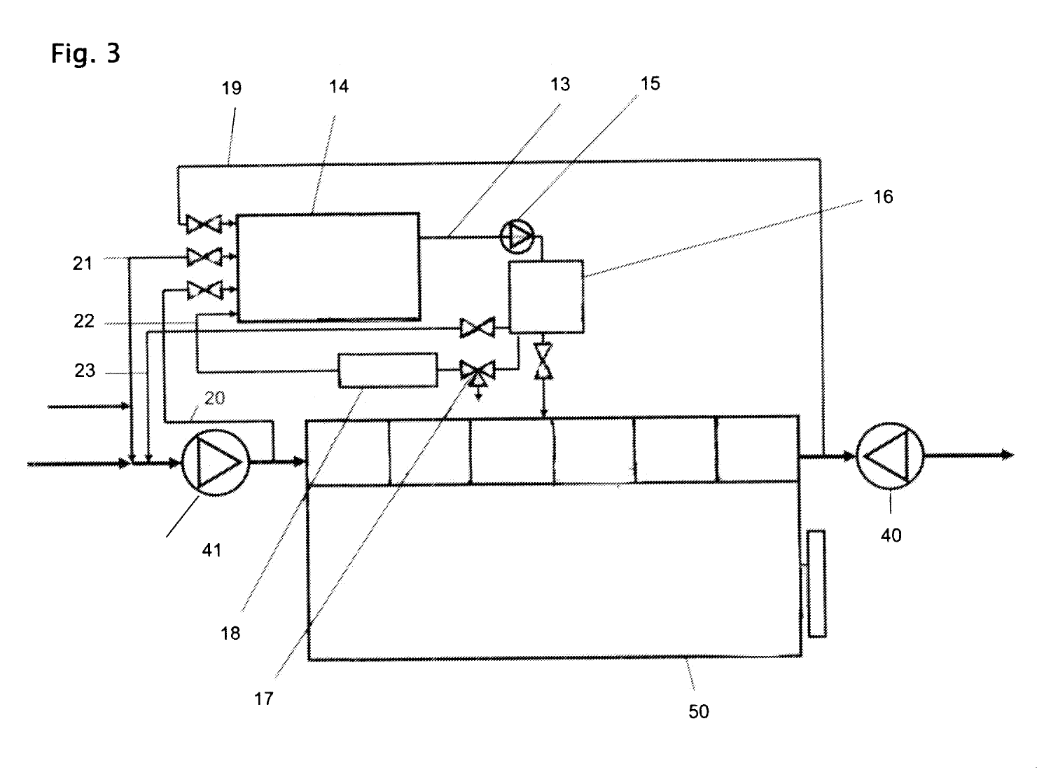

FIG. 3 shows a diagrammatic structure of the internal combustion engine together with reactor.

FIG. 1 shows a cross-sectional view of a cylinder of an internal combustion engine in the form of a gas engine including a cylinder sleeve 3 in which a piston is displaceably mounted. Formed between the cylinder head end 4, the cylinder sleeve 3 and the piston 2 is the main combustion chamber 5 in which the main amount of fuel-air mixture is burnt. For that purpose, fuel and air are introduced through intake valves which are not shown. In the course of the compression stroke a part of that mixture flows by way of the flow transfer bores 8 into the prechamber 1 into which a spark plug 7 projects.

Conventionally an additional fuel gas feed can also be provided here. In the state of the art ignition of the mixture then occurs in the prechamber 1 by way of the spark plug 7. Ignition flares issue by way of the flow transfer bores 8, which ignite the compressed fuel-air mixture in the main combustion chamber 5 and initiate the working stroke of the cylinder.

The feed 6 is provided to feed a combustion gas or a combustion gas-air mixture to the prechamber separately from the main gas/air mixture, in which case the prechamber is for the greatest part flushed free from the burnt residual gases of the preceding working stroke.

According to the invention a defined amount of CO₂ for avoiding soot formation is introduced into the prechamber by way of that scavenging gas feed which represents the state of the art, in addition to the combustion gas or the combustion gas-air mixture.

In a preferred variant however the feed 6 into the prechamber is connected to a thermochemical reactor as shown in FIG. 2, with which the desired amount of CO₂ is produced from the combustion gas and further reactants. The thermochemical reactor 14 has an outlet 30 opening into the feed 6 of the prechamber 1. In addition the thermochemical reactor includes inlets for fuel gas 32, air 33, water vapor 34 and engine exhaust gas 35. Those additions of given amounts of gas can be delivered by way of individual valves which are controllable, and are then introduced into the thermochemical reactor 14. The substance flows involved in the reaction of fuel gas, air, water vapor and engine exhaust gas are fed to the thermochemical reactor 14 in separate lines provided with metering devices and regulating and control valves. After mixing of the substance flows, that mixture is heated to about 600° C. in the counterflow heat exchanger 31. Superheating to about 850° C. is then effected in a prereaction chamber 9. Catalysts for example of nickel are provided in the prereaction chamber. At that temperature, the gas mixture then passes into the reforming stage 10 where further reaction steps takes place. The product gas issuing from the reforming stage 10 at about 700° C. is passed back to the counterflow heat exchanger 31 where it heats the incoming mixture. After cooling the product gas is compressed, dried and fed to the prechambers.

The higher the proportion of water vapor in the gas mixture at the reactor intake, the correspondingly greater is the reaction equilibrium displaced towards H₂ and CO₂ to the detriment of CO and the correspondingly lower is the risk of sooting of the catalyst surface. The amount of exhaust gas has the same effect. The exhaust gas also has energy advantages over the use of water vapor, besides the chemical advantages, so that in the ideal case it is possible to dispense with the metered addition of water vapor, by the use of exhaust gas.

The engine exhaust gas is usually composed of the components water vapor at about 11% by volume, CO₂ at about 5% by volume O₂ at about 10% by volume. The balance is nitrogen and other trace components.

Water vapor and air are already present in the exhaust gas so that the corresponding substance flows by way of the feed 33, 34 can be reduced. In addition the exhaust gas in the case of internal combustion engines with an exhaust gas turbocharger can be removed upstream of the exhaust gas turbine at high pressure and high temperature, thereby giving considerable energy advantages.

According to the invention it has proven desirable if the amount of gas fed to the reactor 14 is between about 1 and 2% by volume of the total fuel gas amount for the engine. In relation thereto the amount of exhaust gas fed to the reactor is between about 0 and twice that gas volume flow.

FIG. 3 diagrammatically shows an internal combustion engine having a thermochemical reactor 14 and the corresponding line conduits and feed lines. The various substance flows are fed to the thermochemical reactor 14 by way of suitable metering and mixing devices. The main part of the combustion gas provided for prechamber scavenging is fed to the reactor by way of a line and a metering valve 21. The remaining part passes to the thermochemical reactor by way of the gas air guide means 20, with which the proportion of air is also fed. The amount of exhaust gas is introduced by way of the feed line 19 and the required proportion of water vapor is provided by way of the line 22. The product gas is compressed by the compressor 15 to the pressure require for scavenging of the prechambers and passed to a buffer volume 16. Condensate separation 17 is effected therein and further passed to the prechambers and for a small part to the engine intake upstream of the exhaust gas turbocharger. The proportion of water vapor is introduced into the reactor after evaporation of the condensate 18.

As already stated the required quantitative ratio of the substance flows depends on different parameters, for example the engine load, the composition of the fuel gas and the specific configuration and mode of operation of the reforming apparatus (for example temperature level and catalyst material).

The water vapor introduced into the thermochemical reactor is chemically used up only in respect of a small part. The predominate part leaves the reformer with the reforming gas and is condensed out after the cooler and recycled to the reforming process.

The combustion characteristics of the internal combustion engine can be influenced by the ratio of the meteredly added exhaust gas to the fuel gas to be reformed. With a higher proportion of exhaust gas combustion in the prechamber becomes cooler and the ignition pulse into the main combustion chamber becomes weaker. In that way for example the combustion duration can be increased and, while accepting a somewhat worse level of efficiency of the internal combustion engine, it can thereby become somewhat more knock-resistant and the maximum cylinder pressure can be reduced. That effect can be desirable, for example for optimum adaptation of the combustion procedure to combustion gases with an antiknock property which varies in respect of time, or for representing a time-limited overload mode of operation, for example for covering a peak load.

The preferred solution proposed further provides that the operating condition of the internal combustion engine, that is detected by the engine management system, as well as the gas composition ascertained by suitable gas sensors at the exit from the reactor, are used for metering the substance flows into the reactor. Sensors for the gas components hydrogen, carbon monoxide and carbon dioxide are used for measuring the gas composition, in which respect the measurement of CO₂ may already be sufficient.

Besides the above-mentioned substance flows, it is also possible in addition to feed a further or additional substance flow to the thermochemical reactor 14. That can be for example a combustible medium, for example a gaseous or liquid fuel, or also an external CO₂ source.

The feed of a separate combustion gas is proven to be advantageous in particular when the main fuel for the engine is a combustion gas with a very low calorific value. In such cases the use of the fuel gas of the internal combustion engine as a starting basis for the thermochemical conversion of substances in the thermochemical reactor 14 would entail detrimental combustion properties in the prechambers. The use of fuels with a high calorific value and which are present for example in liquid form for better storage makes it possible to produce a reforming gas with a relatively high calorific value, with good combustion properties.

The production of a scavenging gas of the optimum composition, independently of the nature of the main combustion gas, permits markedly better utilisation capability of fuel gases with a very low calorific value. Stack gas or blast furnace gas can be named by way of example as fuel gases with a low calorific value. As alternative scavenging gas fuels, it is possible for example to use diesel fuel or heating oil, LPG (butane or propane) or biogenic fuels like ethanol or methanol.

For stabilisation and easier and operationally more reliable regulation and control of the thermochemical process in the reactor it is advantageous to produce a larger amount of product gas in the reactor, than is required for scavenging of the prechambers, with the excess amount being fed to the engine together with the combustion air and with the main gas amount. That is effected by way of the line 23.

It will be seen from FIG. 3 that the internal combustion engine 15 is a mixture-charged internal combustion engine with an exhaust gas turbocharger. The turbocharger comprises an exhaust gas turbine and a compressor which are connected together by way of a common shaft. Opening into the turbocharger compressor 41 are on the one hand fuel gas and on the other hand air, as well as the outlet from the buffer storage means 16. In terms of control and regulation of the thermochemical process for producing scavenging gas of a suitable composition it is preferable to aim for a volume ratio of CO₂ to H₂ in a range of between 70:30 and 40:60 to minimise soot formation.

1. A method of operating an internal combustion engine, in particular a gas Otto cycle engine with prechamber ignition, wherein a gas mixture is fed to the prechamber from the exterior as scavenging gas, whose CO₂ content is controlled or regulated and wherein hydrogen is additionally added to the scavenging gas.

2. A method as set forth in claim 1 characterised in that the CO₂ entirely or partially originates from the exhaust gas of the internal combustion engine.

3. A method as set forth in claim 1 characterised in that the CO₂ entirely or partially is produced in a thermochemical reactor.

4. A method as set forth in claim 1 characterised in that the hydrogen is produced by a vapor reforming process.

5. A method as set forth in claim 4 characterised in that the CO₂ is fed to the vapor reforming process from the exhaust gas of the internal combustion engine jointly with fuel.

6. A method as set forth in claim 2 characterised in that the hydrogen is produced by a vapor reforming process.

7. A method as set forth in claim 3 characterised in that the hydrogen is produced by a vapor reforming process.
